(19) United States
(12) Patent Application Publication
(10) Pub. No.: US 2008/0115328 A1
(43) Pub. Date: May 22, 2008

(54) APPARATUS AND METHOD FOR HINGE LUBRICATION

(76) Inventors: John C. Tomaini, Warwick, NY (US); Donald J. Ranft, Hershey, PA (US)

Correspondence Address: COLLEN IP, THE HOLYOKE MANHATTAN BUILDING, 80 SOUTH HIGHLAND AVENUE, OSSINING, NY, 10562, US

(21) Appl. No.: 11/562,066

(22) Filed: Nov. 21, 2006

(51) Int. Cl. E05D 5/10

(52) U.S. Cl. 16/386

(57) ABSTRACT

This invention provides a novel apparatus and method for allowing easy lubrication of a hinge without requiring even a partial removal of the pin. The preferred embodiment includes a hole in the top of the hinge pin which is extended to a groove or channel on the outer surface of the pin. The groove can extend in a spiral downward slope to the bottom of the pin. In other embodiments the hinge pieces and not the hinge pin are created with a path for lubricant to reach the space between the hinge pieces and pin. A channel can be included on the inner surface of the hinge pieces to ensure better distribution of the lubricant.

### FIELD OF INVENTION

The field of invention relates to hinges and the means to lubricate.

### BACKGROUND OF INVENTION

The present invention relates to a method and device for applying lubrication to a hinge. Hinges for doors, gates, cabinets, etc. typically include a hinge pin inserted downward from the top of the hinge. Since the 2 hinge pieces which are secured to the door and the door opening must rotate around the hinge pin, lubrication is required. After repeated use and over time the lubrication must be reapplied. The common method to add lubrication involves at least partially removing the hinge pin, adding lubrication and reinserting the hinge pin fully into the hinge.

Even partially removing the hinge pin can be a real problem, especially where a hinge is located close to a floor or other surface under the door. If the hinge pin is removed too for the part of the hinge secured to the door may shift require realigning the 2 secured pieces to each other to allow reinsertion of the pin.

### BRIEF SUMMARY OF INVENTION

This invention addresses these problems in lubricating a hinge by providing a device and method to allow adding lubrication without requiring even partial removal of the hinge pin.

### DETAILED DESCRIPTION OF DRAWINGS

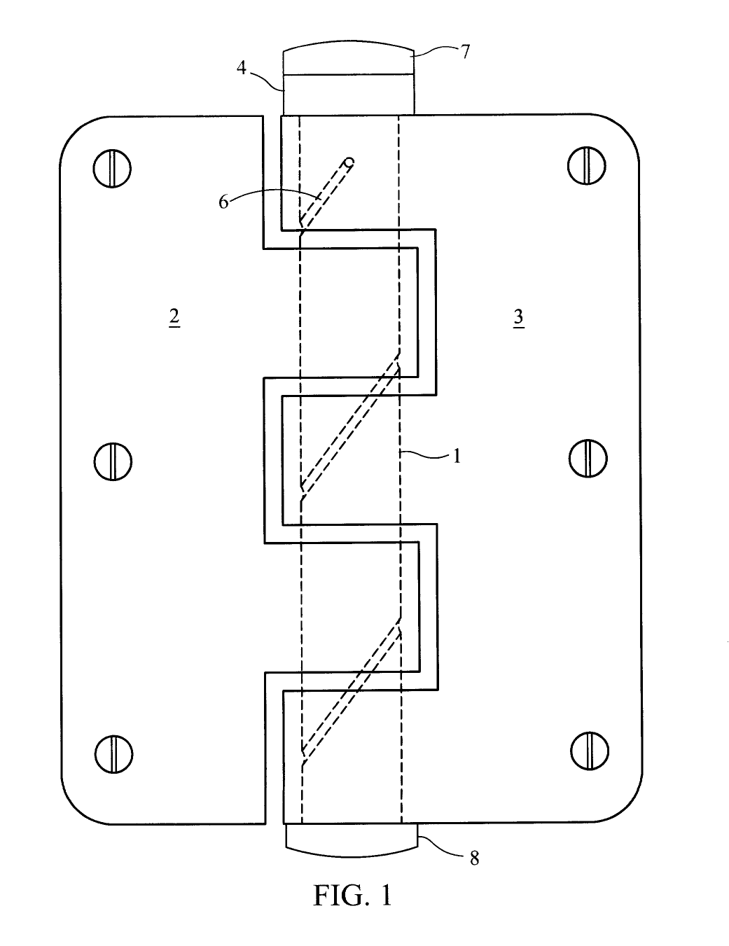

FIG. 1 is a front cross-section view of a hinge with pin inserted.

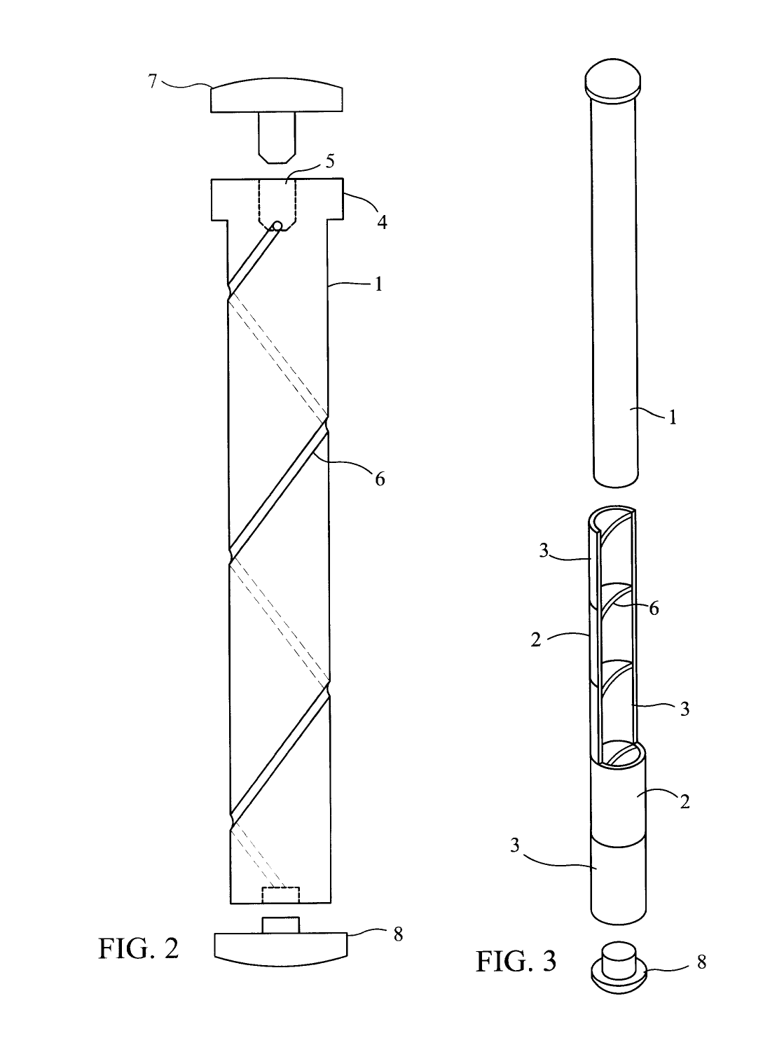

FIG. 2 is a front view of a hinge pin.

FIG. 3 is a front view of a hinge cut view of another embodiment with the hinge pin removed.

### DETAILED DESCRIPTION OF PREFERRED EMBODIMENT

As depicted in FIG. 1, this invention involves a modified design for the standard hinge pin. This invention allows oil, grease or other lubrication to access the space between the pin (1) and the hinge pieces (2 and 3). The hinge pieces (2 and 3) are securely mounted to surfaces of two objects to be rotated/pivoted in relation to each other such as a door and door frame. The top of a typical hinge pin (4) is a wider diameter than the rest of the pin to prevent the pin from falling out the bottom of the hinge pieces (2 and 3). As depicted in FIG. 2, this invention adds a hole (5) in the top of the hinge pin (4). This hole allows the lubricant to be added and captured in the pin. The hole (5) also acts as a small reservoir to allow time for the oil to flow down the pin (1). To facilitate the flow of the lubricant down to the full length of the pin (1), the pin includes a channel or groove (6) extending from the hole (5) in spiral or criss-cross pattern down to the bottom of the pin.

A dust cap (7) covers the hole when lubrication is not being added. In addition, a drip cap (8) can be added on the bottom of the pin and designed to accept any excess oil which makes it to the bottom of the pin.

When the hinge requires lubrication, the dust cap (7) is removed and lubrication added into the hole (5) in the top of hinge pin (4). For a typical house door or gate only a few drops of oil would be required. The door or gate is then swung back and forth in open and closed directions to facilitate the coating of the hinge pin (1) and the hinge pieces (2 and 3) by the lubricant. If required, additional lubricant can be added until the hinge is properly lubricated which is typically evidenced by no more squeaking. The drip cap (8) can be removed when the lubrication is done to empty any excess lubricant it has captured.

In another embodiment of this invention, in lieu of the hole (5) the top of the hinge pin (4) has a notch in the external circumference and extending to the channel (6). The notch can be sized to allow space for an appropriate reservoir between the pin (1) and the hinge pieces (2 and 3). If a dust cap is desired for the embodiment, it is designed appropriately to cover the notch. While a channel facilitates penetration of the lubricant down the pin, providing access to the space between hinge and pin without a channel may be sufficient. Thus in a further embodiment a notch or hole to the space between hinge and pin is provided with no channel.

The drip cap (8) can be designed with open space to capture excess lubricant as envisioned to be warranted based on size of hinge and intended lubricant.

In another embodiment of this invention, as depicted in FIG. 3 a channel is provided in at least one of the hinge pieces (2 and 3) instead of being in the hinge pin (1). A notch or hole is provided near the top of a hinge section and extending into the inside wall of the space designed to surround the hinge pin. A channel in the hinge piece section wall extends in a crisscross or spiral pattern from the notch to the bottom of the hinge piece section (2 and 3). In a further embodiment, notches and channels can be provided in additional hinge piece sections as depicted in FIG. 3 to ensure lubricant access the full length of the hinge and pin.

In another embodiment of this invention a hole is drilled from the outer surface of a hinge piece into the space designed to capture the hinge pin. Thus this can easily be done on existing hinges without replacement.

The above is a detailed description of particular embodiments of the invention. It is recognized that departures from the disclosed embodiments may be made within the scope of the invention and that obvious modifications will occur to a person skilled in the art. Those of skill in the art should, in light of the present disclosure, appreciate that many changes can be made in the specific embodiments which are disclosed herein and still obtain a like or similar result without departing from the spirit and scope of the invention. All of the embodiments disclosed and claimed herein can be made and executed without undue experimentation in light of the present disclosure.

We claim:

1. A hinge comprising:
a first hinge piece securely mounted to a surface;
a second hinged piece securely mounted to a second surface which is to be pivoted about the first surface;
a hinge pin designed to be inserted into openings in each hinge piece to hold them together;
a hole in the top of the hinge pin and a channel extending in a downward-sloped spiral pattern around the outer surface of the pin from the hinge pin hole down to the bottom of the hinge pin.

2. A hinge according to claim 1 further comprising a removable dust cap to cover the hole in the top of the hinge pin, and a removable drip cap on the bottom of the hinge

3. A hinge according to claim 2 in which the drip cap is designed with open space to capture any excess lubricant.

4. A hinge according to claim 1 in which instead of the hole, the pin is fabricated with a notch in the external circumference of the top of the hinge pin with the notch extending to the channel.

5. A hinge comprising:
a first hinge piece securely mounted to a surface;
a second hinged piece securely mounted to a second surface which is to be pivoted about the first surface;
a hinge pin designed to be inserted into openings in each hinge piece to hold them together;
a notch extending from the outer face of the first hinge piece into the inner wall of a space designed to capture the hinge pin.

6. A hinge according to claim 5 in which the notch ends at a channel in the inner wall of the space designed to capture the hinge pin and the channel extending in a downward sloped pattern to the bottom of the hinge piece.

7. A hinge according to claim 6 in which the first and second hinge pieces are comprised of alternating sections which are aligned to allow insertion of the hinge pin.

8. A hinge according to claim 7 in which the notch and channel are provided in each section in both the first and second hinge pieces.

9. A method for allowing lubrication of a hinge comprising:
fabricating a hinge pin with a hole in the top of the pin;
extending the bottom of the hole to a channel on the outer surface of the pin; and
extending the channel in a spiral downward slope pattern to the bottom of the pin.

10. A method according to claim 9 in which instead of the hole, the pin is fabricated with a notch in the external circumference of the top of the hinge pin and extending to the channel on the outer surface of the pin.

11. A method according to claim 9 further comprising a removable dust cap to cover the hole in the top of the hinge pin and a removable drip cap at the bottom of the hinge pin.

12. A method according the claim 11 further comprising fabricating the drip cap with open space to capture any excess lubricant.

13. A method for allowing lubrication of a hinge comprising fabricating a hinge piece with an opening in a downward slope from its outer surface into the inner wall of a space designed to capture a hinge pin.

14. A method according to claim 13 in which the opening in a downward slope is created by drilling a hole from the outer surface of the hinge piece into the space designed to capture a hinge pin.
